(19) United States
(12) Patent Application Publication
(10) Pub. No.: US 2010/0284581 A1
(43) Pub. Date: Nov. 11, 2010

(54) METHOD AND DEVICE FOR ACQUIRING AND PROCESSING DATA FOR DETECTING THE CHANGE OVER TIME OF CHANGING LESIONS

(75) Inventors: Laurent Petit, Peymeinade (FR); Philippe Andres, Peymeinade (FR)

Correspondence Address: MEYERTONS, HOOD, KIVLIN, KOWERT & GOETZEL, P.C., P.O. BOX 398, AUSTIN, TX, 78767-0398, US

(73) Assignee: GALDERMA RESEARCH & DEVELOPMENT, S.N.C., Biot (FR)

(21) Appl. No.: 12/599,618

(22) PCT Filed: May 28, 2008
(86) PCT No.: PCT/FR2008/050923

§ 371 Date: Jul. 19, 2010

(30) Foreign Application Priority Data
May 29, 2007 (FR) 0755305

(51) Int. Cl. G06K 9/00

(52) U.S. Cl. 382/128

(57) ABSTRACT

This method for acquiring and processing data for detecting the change over time of changing lesions includes: successive data acquisitions according to different acquisition methods, so that, at each moment of acquisition, the user forms a set of data obtained according to respective acquisition methods; storage of the acquired data in a database; and displaying the data by selecting and displaying the selected data on a display screen. During displaying an item of data, the user inserts into an image being displayed at least one matching data item extracted from the database.

### BACKGROUND OF THE INVENTION

1. Field of the Invention

The invention relates to the field of data processing and, in particular, to the field of processing dermatological image data. More particularly, the invention relates to the acquisition and processing of data for detecting the change over time of changing lesions. A particularly worthwhile application of the invention therefore relates to the monitoring of the change over time of the acned state of the skin.

2. Description of the Relevant Art

The change in a dermatological pathology, such as acne, can be monitored by image processing. However this requires, in this case, using records of successive snapshots obtained at different times of an organ to be monitored, in this instance the skin, and comparing the data thus obtained in order to detect the appearance and the development of new lesions or conversely their disappearance.

In order to allow an effective comparison of the images, it is necessary to reposition the images in order to make it possible to superpose them or, in a general manner, to allow a comparison of identical surfaces of the monitored organ.

In this respect it is possible to refer to documents FR A 2 830 961 and FR A 2 830 962 in which, after display, the images undergo a preprocessing in order, on the one hand, to carry out a geometric repositioning of the images relative to a reference image, and, on the other hand, to correct skewing generated by greater or lesser differences in intensity between zones of one and the same image.

Moreover, for the purpose of making the detection and monitoring of the changes in the lesions easier, it has been proposed to take pictures by means of different types of lighting in order, for example, to make it easier to assess the relief or the inflammation of the lesions and to make it easier to identify them and count them.

However, according to the various, conventionally used, techniques for acquiring and processing images, the various images are viewed by selecting them and displaying each of the images successively, one after the other, which makes it relatively awkward and inefficient to compare them.

Moreover, it has been noted that monitoring the change in a pathology requires the practitioners or research laboratories to monitor the change in the pathology over a relatively long period which may be as much as six months, in order to determine the effectiveness of a product.

### SUMMARY OF THE INVENTION

It is desirable to remedy the drawbacks associated with the conventional image acquisition and processing techniques and, in particular, to improve the proposed functionalities in order to make comparisons between data easier, particularly image data.

It is further desirable to have a method and a device for acquiring data, particularly image data, which make it possible to considerably reduce the evaluation time of a treatment.

In one embodiment, a method for acquiring and processing data for detecting the change over time of changing lesions, includes:
successive data acquisitions according to different acquisition methods, so that, at each moment of acquisition, the user forms a set of data obtained according to respective acquisition methods;
storage of the acquired data in a database; and
displaying the data by selecting and displaying the selected data on a display screen.
   In addition, during displaying an item of data, the user inserts into an image being displayed at least one matching data item extracted from the database.

According to another embodiment, the data includes image data.

Therefore, in one exemplary embodiment, the user successively forms images according to different respective acquisition methods, so that, at each moment of picture-taking, the user forms a set of images obtained according to respective acquisition methods, stores the formed images in the database and displays the images by selection and display of the selected images on a display screen.

In addition, during displaying an image, the user delimits an area of interest in the image and inserts into the image being displayed a matching zone of an image extracted from the database.

It is therefore also possible to associate additional data with the zone imported from another image. Therefore, for example, the images stored in memory being associated with data items relating to a parameter of the surface, the user simultaneously inserts at least one portion of said data from an exported image zone into the area of interest.

It can therefore be conceived that the integration into an image being displayed of a zone extracted from another image of the image base makes it much easier to make the comparison between images and therefore makes it considerably easier to monitor the change in a lesion.

Moreover, the storage of the images in a database allows a file organization in order, for example, to monitor in parallel various types of treatment and facilitate the viewing of the images.

According to another embodiment, the user delimits an area of interest in the displayed image and inserts into the image being displayed a matching zone of an image formed at the same time according to a different acquisition method.

In addition, for example, the images stored in memory are associated with data relating to a parameter of the surface, and the user simultaneously inserts at least a portion of said data from an exported image zone into the area of interest. It is also possible to insert into the image being displayed a matching zone of an image formed according to a different acquisition method.

Advantageously, the area of interest being able to be moved in the image being displayed, the user dynamically updates the portion of the image extracted from the database so as to make it correspond to the area of interest being moved.

According to yet another embodiment, the method also includes processing the images formed by geometrically matching up the images.

For example, processing the images includes the selection of a reference image and the geometric modification of all of the images formed in order to make them match the reference image.

It is also possible to select a reference acquisition method and geometrically modify each image formed based on the other acquisition methods in order to make it match the image formed based on the reference acquisition method.

In one embodiment, processing the images includes:
calculating a set of coefficients of similarity between at least one zone of the image to be processed and one or more matching zones of the reference image;
calculating a transformation function based on the calculated similarity coefficients; and
applying the transformation function to the whole of the image to be processed.

For example, the user generates a vector field of similarity between respective zones of the image to be processed and of the reference image and calculates the transformation function based on the generated vector field.

The processing the images may also include a modification of the intensity of the processed image in order to make it match that of the reference image.

In one embodiment, processing the images may also include a step for displaying the transformation, during which the user applies a grid to the image to be processed, deforms the grid by means of the transformation function and displays the deformed grid on the display screen.

Another embodiment relates to a device for acquiring and processing data for the detection of the change over time of changing lesions, including data acquisition means suitable for the successive acquisition of the data according to different acquisition methods, so that, at each moment of acquisition, the user forms a set of data obtained according to respective acquisition methods, a database for the storage of data sequences thus acquired, a display screen for displaying data extracted from the database and a central processing unit including means for inserting into an image being displayed at least one matching data item extracted from the database.

According to another feature of this device, the data include image data.

Therefore, for example, this device includes picture-taking means associated with acquisition means jointly suitable for forming successive images according to different acquisition methods so that, at each moment of picture-taking, the user forms a set of images obtained according to different acquisition methods.

In addition, the central processing unit is associated with a man-machine interface including means for delimiting an area of interest in an image being displayed.

The central unit may also include means for inserting into said image a matching zone of an image extracted from the database.

According to yet another feature of this device, the means for inserting into said image a matching zone from an image extracted from the image base includes means for dynamically generating said zone as a function of a movement of the area of interest in the image being displayed.

According to yet another feature of this device, the central processing unit also includes means for transforming the images in order to geometrically deform the images in order to make them match a reference image.

For example, the means for transforming the images includes means for delimiting at least one calibration zone in said images, means for calculating a coefficient of similarity between the calibration zones of an image to be deformed, on the one hand, and of the reference image, on the other hand, and for calculating a transformation function based on the calculated coefficients, and means for applying said function to the whole of the image to be deformed.

The central unit may also include intensity-control means suitable for modifying the intensity of each transformed image in order to make it match that of the reference image.

### BRIEF DESCRIPTION OF THE DRAWINGS

Other objects, features and advantages of the invention will appear on reading the following description, given solely as a nonlimiting example, and made with reference to the appended drawings, in which:

FIG. 1 is a block diagram illustrating the general architecture of an image acquisition and processing device;

FIG. 2 is a block diagram showing the structure of the central unit of the device of FIG. 1;

FIGS. 3 and 4 illustrate the method of repositioning the images;

FIGS. 5 to 9 show the man-machine interface of the device of FIG. 1 making it possible to adjust display parameters and choose an area of interest;

FIG. 10 shows the procedure for superposing a zone extracted from another image in the area of interest;

FIGS. 11 and 12 illustrate the procedure for automatic detection of lesions; and

FIG. 13 illustrates a flow chart illustrating the operation of the image acquisition and processing procedure.

While the invention may be susceptible to various modifications and alternative forms, specific embodiments thereof are shown by way of example in the drawings and will herein be described in detail. The drawings may not be to scale. It should be understood, however, that the drawings and detailed description thereto are not intended to limit the invention to the particular form disclosed, but to the contrary, the intention is to cover all modifications, equivalents, and alternatives falling within the spirit and scope of the present invention as defined by the appended claims.

### DETAILED DESCRIPTION OF THE PREFERRED EMBODIMENTS

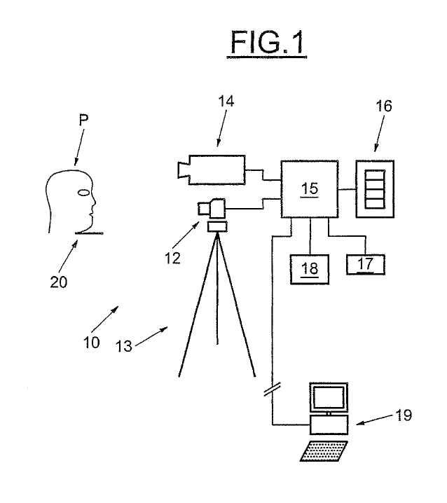

With reference to FIG. 1, it shows the general architecture of an image acquisition and processing device, indicated by the general reference number 10.

In the exemplary embodiment shown, this device is designed to monitor the change over time of acned lesions by taking successive snapshots over predetermined periods of time of the skin of a patient, and archiving the images formed, displaying them and comparing them.

It will be noted however that such a device is designed to monitor the change over time of changing lesions, such as acne, psoriasis, rosacea, pigment disorders, onychomycosis, actinic keratosis and skin cancers.

Such a device can therefore advantageously be used by practitioners to determine the effectiveness of a treatment or, for example, to run clinical tests in order, in the same way, to assess the effectiveness of a new product.

It must be noted however that the embodiments of the device disclosed herein are not limited to use in the dermatology field and may also be applied mutatis mutandis to any other field in which it is necessary to carry out a comparative analysis of successive images of an organ or, in general, of a surface to be examined.

It should similarly be noted that no departure is made from the context of the invention when the change over time of changing lesions is monitored based on a periodic acquisition of data of other types, on archiving of these data and on subsequent processing of these data.

As can be seen in FIG. 1, in the embodiment illustrated in which the data are image data, the device 10 includes a camera 12 placed on a fixed support 13 and a lighting device 14 connected to a central unit 15 including an assembly of hardware and software means making it possible to control the operation of the camera 12 and of the lighting device 14 in order to take pictures of the skin of a patient P according to various lighting methods and to do so in a successive manner and control the subsequent exploitation of the results.

Specifically, in the exemplary embodiment envisaged in which the device 10 is designed to allow a practitioner or a research laboratory to determine the effectiveness of a treatment, the patient P undergoes examination sessions, for example at the rate of one every day, for a period that may be of the order of one month and, on each visit, the user takes pictures according to various lighting methods used respectively to assess various features of the lesions or to acquire data relating to parameters of the skin of the patient.

For example, pictures are taken that are lit with natural light, with parallel-polarized light and with cross-polarized light.

Specifically, the parallel-polarized light makes it easy to assess the reliefs of the lesions while cross-polarized light makes it easier to count the inflamed lesions by improving their display.

The picture-taking methods may also be carried out by UVA lighting or irradiation, in near infrared, by using infrared thermography, or with various wavelengths (multispectral images). It is also possible to carry out an arithmetic combination of these images thus formed.

It is also possible to use other types of lighting or else to combine the formed images with additional data obtained with the aid of appropriate measurement means.

Therefore, in a nonlimiting manner, it would also be possible to combine the image data with data obtained by means of various measurement devices, for example by means of an evaporimeter in order to determine the insensible loss of water from the skin, by means of a sebum meter, in order to determine the ratio of skin sebum or by means of a pH meter for the purpose of determining, for example, the changes sustained by the skin because of a treatment that may be irritating, etc. It would also be possible to associate with the image data information relating to the microcirculation or the desquamation of the skin by using appropriate measurement apparatus, or else relating to hydration by using, for example, a corneometer.

The lighting device 14 incorporates various lighting means making it possible to emit the chosen radiation, for example, as indicated above, according to a normal light, a parallel- or perpendicular-polarized light. However, in other embodiments, the lighting device 14 may also incorporate, if it is desired, a source of UVA rays, a source of rays emitting in the near-infrared field, or in the infrared field or else according to different wavelengths in order to form multispectral images or for the purpose of producing arithmetic combinations of such images.

As can be seen from FIG. 1, the central unit 15 is associated with an image base 16, or in a general manner with a database, in which all of the images taken on each visit are stored and organized according to the various lighting methods associated with additional data delivered by the measurement devices. It is also associated with a man-machine interface 17 consisting, for example, of a keyboard, a mouse, or any other appropriate means for the envisaged use and including a display screen 18 making it possible to display the images formed.

As can be seen, the device 10 can communicate via a wire or wireless link with a remote user terminal 19 or with a network of such terminals making it possible, for example, to remotely retrieve, view, compare and exploit the images stored in the database 16.

Finally, for the purpose of making the picture-taking conditions substantially reproducible, the device 10 is supplemented by a support 20 placed at a distance and at a fixed height relative to the camera 12 in order to allow a precise positioning of the zone of the body of the patient P relative to the latter.

The support 20 may advantageously be supplemented by additional means making it possible to accurately position and maintain the chosen bodily zone, for example in the form of a chin rest or resting surfaces for the head of the patient so that, on each visit, the face of the patient is positioned precisely relative to the camera.

However, in order to improve the performance of the device and to make the images comparable with one another by placing the parts of the body in exact correspondence from one examination to another, the central unit carries out a preprocessing of the formed images by geometric repositioning of the images.

Depending on the case, this repositioning may be rigid, that is to say that it does not change the shapes, or else nonrigid, or else affine, and will therefore change the shapes according to a certain number of degrees of freedom.

As will be described in detail below, this repositioning is carried out relative to a reference image, that is to say, on the one hand, relative to an image formed during a reference examination and, on the other hand, relative to a reference image. For example, this reference image may consist of an image taken according to a predetermined acquisition method, for example taken under natural light.

After this preprocessing has taken place, the images, previously organized, are stored in the image base 16 so that they can subsequently be viewed and compared.

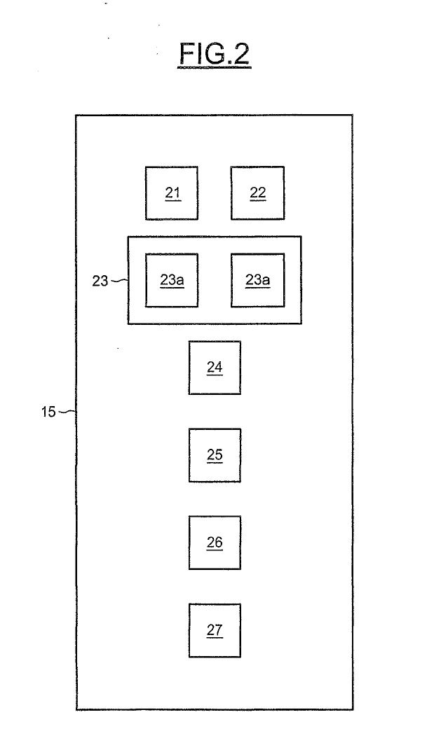

To do this, with reference to FIG. 2, the central unit 15 includes an assembly of hardware and software modules for processing, organizing and exploiting the images.

It thus includes, in the envisaged embodiment, a first module 21 for managing images or data, making it possible to group together patients suffering from one and the same pathology or to create a clinical study relating, for example, to a treatment the performance of which needs to be assessed, or to select an existing study.

This module 21 makes it possible to define and organize, in the database 16, a memory zone given an identifier and containing a certain number of patients, a set of visits, specific picture-taking methods, photographed zones of the body, or even areas of interest in the stored images and parameters to be monitored, originating from the measurement devices.

For example, during the creation of a study via the module 21, the user determines a reference picture-taking method onto which the other images will subsequently be repositioned.

The first management module 21 is associated with a second image-management module 22 which makes it possible to import images into the device 10 and to link them with a previously-created study, to a patient, to a visit, to an area of interest and to a picture-taking method.

The central unit 15 is also provided with an image-repositioning module 23.

This repositioning module 23 includes a first stage 23a repositioning all the images formed during the various visits onto one reference visit and a second stage 23 b repositioning the images of each visit on a reference image taken according to a predetermined picture-taking method, in this instance in natural light.

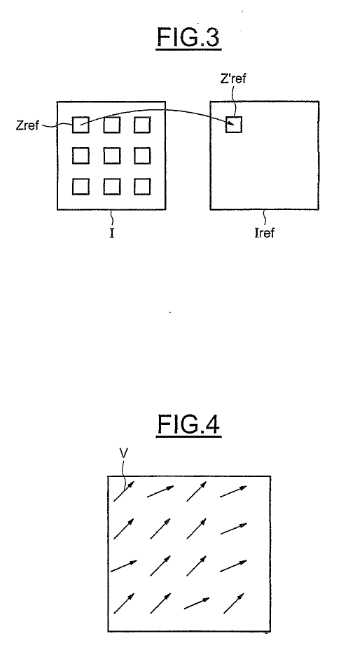

With reference to FIGS. 3 and 4, the repositioning of the images carried out by the central unit 15 is based on a comparison of an image I to be repositioned relative to a reference image Iref.

This involves, in other words, specifying a set of reference zones Zref the number and surface area of which can be programmed and comparing each of the zones Zref with the reference image Iref for example by scanning each reference zone on the reference image.

In practice, this comparison consists in generating a criterion of similarity, for example a coefficient of correlation of the reference zones Zref with the reference image and therefore consists in finding in the reference image the zone Z′ref that is most similar to each reference zone Zref of the image I to be repositioned.

As can be seen in FIG. 4, this calculation makes it possible to generate a field of vectors V each illustrating the deformation to be applied to a reference zone in order to make it match a similar zone on the reference image. Based on this vector field, the image repositioning module makes a calculation of the transformation to be applied to the image I in order to obtain an exact match of one zone of the body of an examination with another or, in general, one image with another.

This involves, in other words, finding the affine or free transformation which makes it possible to represent the vector field best and applying this transformation to the whole of the image.

Since the skin is an elastic material, it has been found that a nonrigid repositioning, that is to say nonaffine, allows a better repositioning of the images after regularization of the vector field, which makes it possible to impose constraints on the transformation and not allow every type of transformation.

Also offered to the user is a representation of the transformation made in order to validate or invalidate the repositioning of an image and thereby prevent a subsequent comparison of images in which the modifications made are too great.

For example, in order to do this, the user superposes on an image to be repositioned a grid or, in general, a notional grid, and applies the same transformation to this grid as that sustained during the repositioning of the images. It is therefore possible to easily assess the level of deformation applied to the image.

After having carried out the repositioning, the central unit 15 can, optionally, correct skewing in the image by correcting the intensity of the repositioned image so that its intensity is similar to the reference image.

After having carried out this preprocessing, the central unit 15 stores the images in the image base 16, the images associated, as appropriate, as indicated above, with additional data. For this purpose, it uses a module 24 for generating a set of repositioned images in order, in particular, to be able to export the images so that they can be used in processing software programs of other types.

The central unit 15 also includes a dynamic module for displaying the set of repositioned images, indicated by the general reference number 25.

This module 25 can be programmed directly via the man-machine interface 17 combined with the screen 18 and includes all the hardware and software means for navigating within the image base 16 in order to display the set of repositioned images, to adjust the display parameters, such as the zoom, the luminosity, the contrast, the picture-taking method displayed, to delimit areas of interest or else, as will be described in detail below, to incorporate in a delimited area in an image being displayed a matching area extracted from another image, for example an image taken according to another picture-taking method.

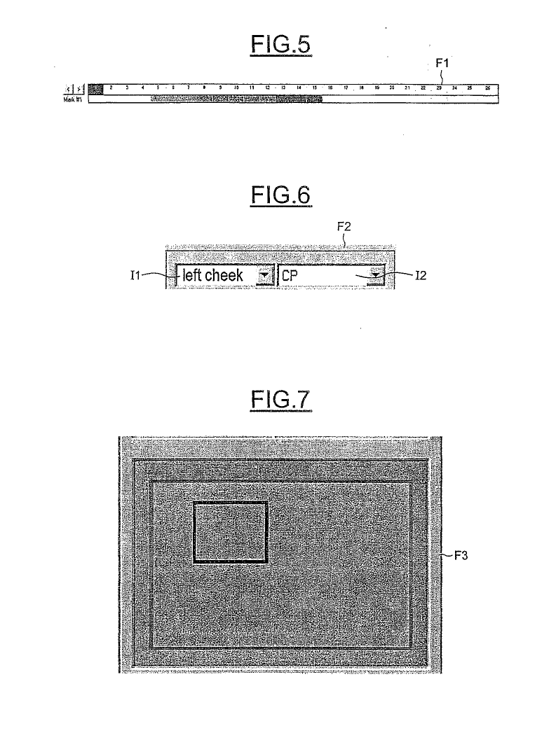

With reference to FIGS. 5 to 9, in order to do this, the central unit 15 generates the display on the screen 18 of a certain number of windows or, in general, of an interface proposing to the user a certain number of tools for allowing such a dynamic display of the images.

First of all, with reference to FIG. 5, a first window F1 is used to display all of the visits previously made and to select one of the visits in order to extract the matching images from the image base.

A second window F2 (FIG. 6) makes it possible to choose, for each image, an acquisition method and additional images relating, for example, to other zones of the photographed face. For example, a first icon I1 makes it possible to select the zone of the face to be identified, for example the right cheek, the left cheek, the forehead, the chin, etc., while a second icon I2 makes it possible to select the exposure method, for example natural light, parallel-polarized or cross-polarized light, etc.

In addition, a control window F3 (FIG. 7) makes it possible to display, in an overall image, an image portion being examined and to rapidly move around in the image.

The central unit 15 can also offer a control window F4 making it possible to adjust the degree of zoom, luminosity and contrast of the displayed image (FIG. 8) or else a window F5 making it possible to select a “diaporama” scrolling method according to which the images of the various visits or of one visit framing a selected visit are shown on the screen with an adjustable scrolling speed (FIG. 9).

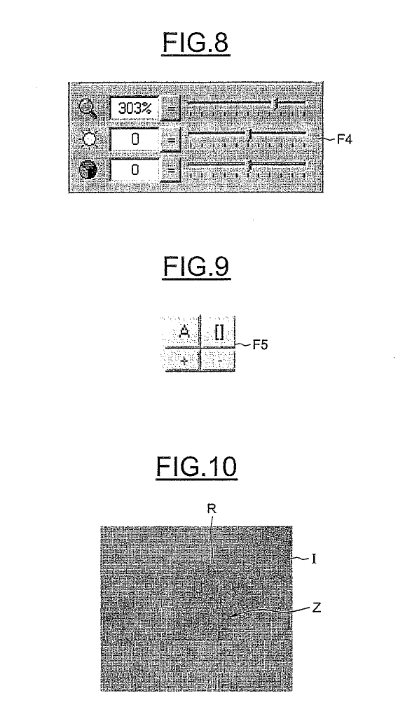

With reference to FIGS. 2 and 10, the processing unit 15 also includes an image processing module 26 which interacts with the display module 25 in order to offer jointly to the user a tool making it possible to select an area of interest R in an image being displayed, to select another image, for example an image taken according to another picture-taking method, to import a zone Z of the selected image matching the area of interest R and to incorporate into the image I the zone Z extracted from the selected image.

Therefore, for example, after having selected an area of interest R and another picture-taking method, the central unit 15 and, in particular, the processing module 26, extracts from the image corresponding to the selection the zone Z matching the area of interest and inserts it in the image in order to be able to dynamically have another picture-taking method in a selected portion of an image being displayed.

Naturally, any other data item extracted from the base, or only a portion of these data, may also be incorporated into the area of interest R instead of or in addition to the imported zone Z, for example any type of data obtained by the various devices for measuring a parameter of the skin, such as pH data, insensible water loss, sebum metric, hydration data such as for example the skinchip or corneometry, microcirculation, desquamation, color or elasticity of the skin.

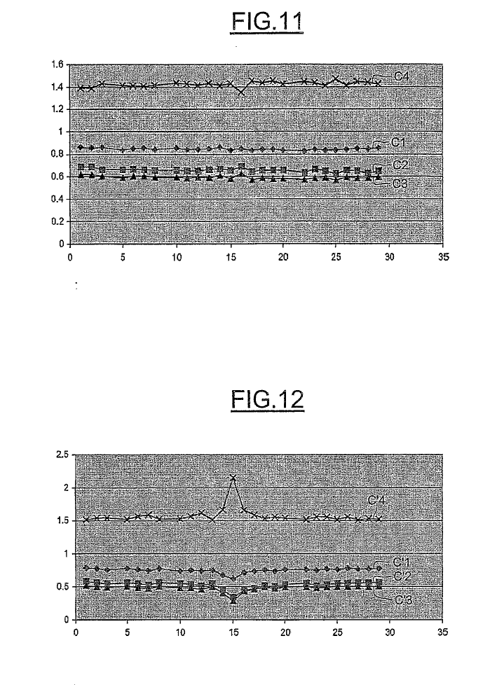

Finally, also with reference to FIGS. 11 and 12, the central unit 15 is furnished with a module 27 for automatic detection of lesions carrying out, for example, a comparison of the data associated with each pixel with a lesion-detection threshold value.

Specifically, with reference to FIG. 11 which relates to a healthy skin, and in which the change in intensity i of an image portion according to time t is shown, for the red color (curve C1), for the green color (curve C2), for the blue color (curve C3) and for the red/blue ratio (C4), it can be seen that, in a healthy area, the profile of the intensities oscillates about a mean value corresponding to the color of the skin.

In contrast, as shown in FIG. 12 which corresponds to a skin having acned lesions, and in which the curves C′1, C′2, C′3 and C′4 correspond respectively to the curves C1, C2, C3 and C4 of FIG. 11, in a damaged area, the profile of intensities as a function of time shows a clearly identifiable peak when it is present on the skin, that is to say that the skin becomes darker or lighter or redder depending on the type of lesion.

It is then possible to detect and automatically qualify the appearance of a lesion by comparing the intensity profiles with a threshold value. For example, as shown, it is possible to compare the profile of variation of the ratio of the red/blue signals with a threshold value of intensity corresponding to a value “2”.

Therefore, as emerges from FIGS. 11 and 12, the module 27 for automatic detection of lesions extracts, for each image, zone by zone, values of the monitored parameters, and thus generates, for all of the images foamed successively over time, and for each parameter, a profile of variation of the parameter as a function of time.

As indicated above, the monitored parameter may consist of any type of parameter associated with the images, and in particular a colorimetry parameter, that is to say, in particular, the intensity of the red, green and blue components and the component ratio, for example the ratio between the intensity of the red component and of the blue component.

The module 27 thus collects all the values of the parameters monitored over a programmable period of time and generates curves illustrating the change in these parameters in order to present them to the user. As shown in FIGS. 11 and 12, it is therefore possible, for example, to obtain the change in the values of the red, green and blue components and the ratio of these components.

For each of the monitored zones, the detection module 27 calculates the difference in the value of the parameters compared with a corresponding lesion-detection threshold value.

Naturally, this calculation is made after the user has selected one or more parameters, depending on the type of lesion to be detected and, if necessary, after the user has entered a threshold value or several respective threshold values.

Specifically, the threshold value which may be stored in memory in the central unit 15 or entered manually can be programmed and depends on the monitored parameter.

As indicated above, the appearance of a lesion is reflected by a variation, in the damaged zone, in the color components. In the example illustrated in FIG. 12, the lesion generates a relatively sharp reduction in the blue and green components, relative to the modification of the red component, which results in a locally large rise in the ratio of the red and blue components throughout the appearance of the lesion.

In this instance therefore it is possible to detect the appearance of the lesion based on the variation in the ratio of the red and blue components, by comparison with a detection threshold value for example set at “2”.

Naturally, another threshold value is used when a lesion is detected based on another parameter.

A lesion is detected by the module 27, zone by zone. Naturally, the dimensions of the monitored zones are a programmable value which depends on the size of the lesions to be detected.

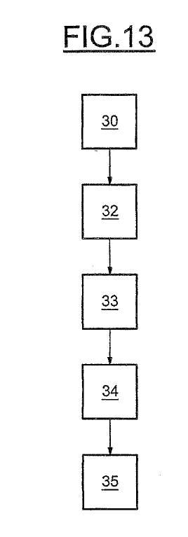

Finally described with reference to FIG. 13 are the main phases of the image acquisition and processing method, for detecting the change over time of acned lesions that is carried out, in the example in question, based on image data formed using respective lighting methods.

During a first step 30, the central unit 15 successively acquires a set of images taken successively over time during various visits by a patient and, for each visit, according to various picture-taking methods.

Subsequently or beforehand, the central unit 15 uses the study management modules and management modules 21 and 22 in order to create a study and to assign the images formed to a previously entered study.

During the next step 32, the images are repositioned, according to the above-mentioned procedure, by using the modules 23 a and 23 b for repositioning the images in order, on the one hand, to reposition the images on a reference visit and, on the other hand, to reposition, on each visit, an image on a reference image taken according to a selected picture-taking method.

After repositioning, a set of repositioned images is generated (step 33) said images then being stored in the image base 16. As indicated above, the image data may be supplemented by data delivered by other types of sensors in order to supplement the available information.

During the next phase 34, at the request of a user, the images stored in the image base 16, supplemented, as necessary, by supplementary data or a portion of such data, can be displayed.

To do so, the central unit 15 offers the user a certain number of interfaces making it possible to select display parameters, choose one or more areas of interest, and navigate from one image to another within the area of interest, to choose various zones of a face, etc.

Further modifications and alternative embodiments of various aspects of the invention will be apparent to those skilled in the art in view of this description. Accordingly, this description is to be construed as illustrative only and is for the purpose of teaching those skilled in the art the general manner of carrying out the invention. It is to be understood that the forms of the invention shown and described herein are to be taken as examples of embodiments. Elements and materials may be substituted for those illustrated and described herein, parts and processes may be reversed, and certain features of the invention may be utilized independently, all as would be apparent to one skilled in the art after having the benefit of this description of the invention. Changes may be made in the elements described herein without departing from the spirit and scope of the invention as described in the following claims.

1. A method for acquiring and processing data for detecting the change over time of changing lesions, comprising:
successive data acquisitions according to different acquisition methods, so that, at each moment of acquisition, the user forms a set of data obtained according to respective acquisition methods;
storage of the acquired data in a database; and
displaying the data by selecting and displaying the selected data on a display screen, wherein, during the step of displaying an item of data, the user inserts into an image being displayed at least one matching data item extracted from the database.

2. The method as claimed in claim 1, wherein the data comprise image data.

3. The method as claimed in claim 2, wherein the user successively forms images according to different respective lighting methods, so that, at each moment of picture-taking, the user forms a set of images obtained according to respective lighting methods, stores the formed images in the database and displays the images by selection and display of the selected images on a display screen.

4. The method as claimed in claim 2, wherein, during displaying an image, the user delimits an area of interest in the image and inserts into the image being displayed a matching zone of a data item extracted from the database.

5. The method as claimed in claim 2, wherein the images stored in memory are associated with data items relating to a parameter of the surface, and in that the user simultaneously inserts at least one portion of said data from an exported image zone into the area of interest.

6. The method as claimed in claim 2, wherein the user inserts into the image being displayed a matching zone of an image formed according to a different acquisition method.

7. The method as claimed in claim 4, wherein the area of interest being able to be moved in the image being displayed, the user dynamically updates the portion of the image extracted from the database so as to make it correspond to the area of interest being moved.

8. The method as claimed in claim 2, further comprising processing the images formed by geometrically matching up the images.

9. The method as claimed in claim 8, wherein processing the images comprises selection of a reference image (Iref) and the geometric modification of all of the images formed in order to make them match the reference image.

10. The method as claimed in claim 8, wherein processing the images comprises selection of a reference acquisition method and the geometric modification of each image formed based on the other acquisition methods in order to make it match the image formed based on the reference acquisition method.

11. The method as claimed in claim 8, wherein processing the images comprises:
calculating a set of coefficients of similarity between at least one zone of the image to be processed (I) and one or more matching zones of the reference image (Iref);
calculating a transformation function based on the calculated similarity coefficients; and
applying the transformation function to the whole of the image to be processed.

12. The method as claimed in claim 11, wherein the user generates a vector field of similarities (V) between respective zones of the image to be processed and of the reference image and calculates the transformation function based on the generated vector fields.

13. The method as claimed in claim 8, wherein processing the images further comprises a modification of the intensity of the processed image in order to make it match that of the reference image.

14. The method as claimed in claim 8, wherein processing the images further comprises the user: applying a grid to the image to be processed, deforming the grid by means of the transformation function and displaying the deformed grid on the display screen.

15. A device for acquiring and processing data for the detection of the change over time of changing lesions, comprising data acquisition means suitable for the successive acquisition of the data according to different acquisition methods, so that, at each moment of acquisition, the user forms a set of data obtained according to respective acquisition methods, a database for the storage of data sequences thus acquired, a display screen for displaying data extracted from the database and a central processing unit comprising means for inserting into an image being displayed at least one matching data item extracted from the database.

16. The device as claimed in claim 15, wherein the data comprises image data.

17. The device as claimed in claim 16, further comprising picture-taking means associated with acquisition means jointly suitable for forming successive images according to different acquisition methods so that, at each moment of picture-taking, the user forms a set of images obtained according to different acquisition methods, the central processing unit being associated with a man-machine interface comprising means for delimiting an area of interest in an image being displayed and means for inserting into said image a matching zone of an image extracted from the database.

18. The device as claimed in claim 17, wherein the means for inserting into said image a matching zone from a data item extracted from the database comprise means for dynamically generating said zone as a function of a movement of the area of interest in the image being displayed.

19. The device as claimed in claim 17, wherein the central processing unit also comprises means for transforming the images in order to geometrically deform the images in order to make them match a reference image.

20. The device as claimed in claim 19, wherein the means for transforming the images comprise means for selecting at least one calibration zone (Zref) in said images, means for calculating a coefficient of similarity between the calibration zones of an image to be deformed, on the one hand, and of the reference image, on the other hand, and for calculating a transformation function based on the calculated coefficients, and means for applying said function to assemblies of the image to be deformed.

21. The device as claimed in claim 19, wherein the central unit comprises intensity-control means suitable for modifying the intensity of each transformed image in order to make it match that of the reference image.
